(19) United States
(12) Patent Application Publication
(10) Pub. No.: US 2024/0149443 A1
(43) Pub. Date: May 9, 2024

(54) TRANSPORTING ITEMS BY AUTONOMOUS MOBILE ROBOTS USING ARTIFICIAL INTELLIGENCE

(71) Applicant: International Business Machines Corporation, Armonk, NY (US)

(72) Inventors: Jeremy R. Fox, Georgetown, TX (US); Michael Boone, Lutz, FL (US); Tushar Agrawal, West Fargo, ND (US); Sarbajit K. Rakshit, Kolkata (IN)

(21) Appl. No.: 17/984,162

(22) Filed: Nov. 9, 2022

(51) Int. Cl. B25J 9/16

(52) U.S. Cl. CPC B25J 9/163

(57) ABSTRACT

A computer-implemented method, system and computer program product for transporting items from one location to another location, such as in a warehouse. A model is built and trained to determine an optimal movement path for transporting items using mobile robots either individually or in cooperation with other mobile robots. After training the model to determine an optimal movement path for transporting items, simulations of mobile robots transporting items from a source location to a target location using various movement paths are performed. An optimal movement path for transporting such items from the source location to the target location is identified using the trained model based on the simulated movement paths, the historical times for the movement of the items using various movement paths, the number of items to be transported and the properties of the items. Available mobile robots are then organized to implement the identified optimal movement path.

### TECHNICAL FIELD

The present disclosure relates generally to autonomous mobile robots, and more particularly to transporting items by autonomous mobile robots using artificial intelligence so as to improve efficiency of item movement, such as the transportation of items in a warehouse.

### BACKGROUND

A mobile robot (also referred to as a “moveable robot”) is an automatic machine that is capable of locomotion. Mobile robots have the capability to move around in their environment and are not fixed to one physical location. Mobile robots can be “autonomous” in that the mobile robots are capable of navigating an uncontrolled environment without the need for physical or electro-mechanical guidance devices. That is, autonomous mobile robots are devices capable of performing tasks and moving around an environment, such as a warehouse, without the need for human intervention.

### SUMMARY

In one embodiment of the present disclosure, a computer-implemented method for transporting items from one location to another location comprises building and training a model to determine a movement path for transporting items using one or more of a plurality of mobile robots either individually or in cooperation with other mobile robots, where each of the plurality of mobile robots has a conveyor belt configured to carry or move one or more items, and where each of the plurality of mobile robots is configured to connect with other mobile robots to create a continuous movement path whereby the conveyer belt on each of the connected mobile robots used to create the continuous movement path is activated to move an item in a same direction. The method further comprises obtaining a source location for a plurality of items to be picked. The method additionally comprises obtaining a target location to receive the plurality of items transported from the source location. Furthermore, the method comprises simulating mobile robots transporting the plurality of items from the source location to the target location using an individual movement path, the continuous movement path or a combination of the individual movement path and the continuous movement path. Additionally, the method comprises identifying a first movement path for transporting the plurality of items from the source location to the target location using the trained model based on the simulations and historical times for movement of items using various movement paths. In addition, the method comprises organizing one or more mobile robots of a plurality of available mobile robots to implement the first movement path to transport the plurality of items from the source location to the target location.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 illustrates the primary physical and logical components of the mobile robot in accordance with an embodiment of the present invention;

FIG. 3 is a diagram of the software components used by the warehouse control system to efficiently transport items, such as in a warehouse, by using artificial intelligence in accordance with an embodiment of the present disclosure.

FIG. 4 illustrates an embodiment of the present disclosure of the hardware configuration of the warehouse control system which is representative of a hardware environment for practicing the present disclosure;

FIG. 5 is a flowchart of a method for transporting items between a source location and a target location by mobile robots using artificial intelligence in accordance with an embodiment of the present disclosure; and

FIG. 6 is a flowchart of a method for continuously determining an optimal movement path for the mobile robots to utilize to transport the items to the target location in accordance with an embodiment of the present disclosure.

### DETAILED DESCRIPTION

As stated in the Background section, a mobile robot (also referred to as a “moveable robot”) is an automatic machine that is capable of locomotion. Mobile robots have the capability to move around in their environment and are not fixed to one physical location. Mobile robots can be “autonomous” in that the mobile robots are capable of navigating an uncontrolled environment without the need for physical or electro-mechanical guidance devices. That is, autonomous mobile robots are devices capable of performing tasks and moving around an environment, such as a warehouse, without the need for human intervention.

For example, a warehouse may utilize hundreds if not thousands of autonomous mobile robots to perform various tasks, such as selectively picking and moving an item (e.g., good), a set of items or even an entire shelf of items from one location in the warehouse to another location in the warehouse. These autonomous mobile robots are equipped with advanced sensors and a digital layout of the warehouse which allows them to interpret their surroundings. Generally, such autonomous mobile robots are charged with moving lightweight unit loads, such as small items, although there are also those made to even handle pallets of goods.

In a storage environment, autonomous mobile robots are integrated with a warehouse control system, which, in turn, is linked to the warehouse management system. Aided by software applications, autonomous mobile robots identify and sidestep any obstacles they come across as they move items within the warehouse.

Autonomous mobile robots may perform various functions in a warehouse environment, including picking and transporting. For example, a worker may select the item(s) from the shelves and deposit them on the robot. The autonomous mobile robot then serves as a picking cart in which the mobile robot itself takes the item(s) and transports them to a destination, such as the consolidation and packaging zone.

In another example, the autonomous mobile robot is responsible for selecting the item(s) from the shelves or even the entire shelf of items. Such item(s) are then transported to a destination, such as the consolidation and packaging zone. In the scenario in which the entire shelf was taken by the mobile robot, the mobile robot may return the shelf to its place and perform the next task.

In order to ensure a continuous flow of items within the warehouse, such as a continuous flow of items from a source location (e.g., item located at aisle A, unit BA, row X) to a target destination (e.g., packaging zone), multiple robots may be required to transport such items and/or have the same robot perform multiple trips to transport such items. As a result of such movements by the autonomous mobile robots, the item movement time in the warehouse may be quite large.

Unfortunately, there is not currently a means for efficiently transporting items, such as between a source location and a target location within a warehouse, so as to reduce such item movement time in a warehouse.

The embodiments of the present disclosure provide a means for efficiently transporting items, such as in a warehouse, by using artificial intelligence to implement a continuous movement path or a combination of a continuous movement path and an individual movement path when it is more efficient to transport items in such a manner versus simply having multiple mobile robots individually transport such items or having mobile robots make multiple trips to transport such items. In one embodiment, each autonomous mobile robot (also referred to herein as simply “moveable robot,” “mobile robot” or “robot”) may be equipped with a conveyer belt configured to carry or move one or more items. Such a conveyer belt may be locked so that the conveyer belt will not move when a mobile robot is individually carrying the item from one location to another. Alternatively, such a conveyer belt may be activated to move. A “continuous movement path,” as used herein, refers to connecting multiple mobile robots in such a manner where the conveyer belt on each of the connected mobile robots is activated to move the item in the same direction (i.e., conveyer belts of the connected mobile robots are moving in the same direction). An “individual movement path,” as used herein, refers to utilizing a single mobile robot to transfer an item(s) from a source location to a target location. By implementing a continuous movement path or a combination of a continuous movement path and an individual movement path when it is more efficient (use less time) to transport items in such a manner versus simply having multiple mobile robots individually transport such items or having mobile robots make multiple trips to transport such items, the item movement time in a warehouse will be reduced. A further discussion regarding these and other features is provided below.

In some embodiments of the present disclosure, the present disclosure comprises a computer-implemented method, system and computer program product for transporting items from one location to another location, such as in a warehouse. In one embodiment of the present disclosure, a model is built and trained to determine an optimal movement path for transporting items using mobile robots either individually or in cooperation with other mobile robots. In one embodiment, each of the mobile robots has a conveyor belt configured to carry or move one or more items, where each of the mobile robots is configured to connect with other mobile robots to create a continuous movement path whereby the conveyer belt on each of the connected mobile robots used to create the continuous movement path is activated to move an item in a same direction. An “optimal movement path” (also referred to herein as simply “optimal path”), as used herein, refers to a movement path that takes the least amount of time to transport an item(s) from the source location to the target location. A “movement path,” as used herein, refers to a course of movement of picked item(s) from the source location to the target location. There are many different types of movement paths, including an individual movement path, a continuous movement path and a combination of a continuous movement path and an individual movement path. An “individual movement path,” as used herein, refers to utilizing a single mobile robot to transfer an item(s) from a source location to a target location. A “continuous movement path,” as used herein, refers to connecting multiple mobile robots in such a manner where the conveyer belt on each of the connected mobile robots is activated to move the item in the same direction (i.e., conveyer belts of the connected mobile robots are moving in the same direction). In one embodiment, the model is trained to predict the optimal path based on historical information pertaining to the movement of items using various movement paths (e.g., individual movement paths, continuous movement paths, a combination of continuous and individual movement paths, etc.). Such historical information includes the time for the movement of the items using various movement paths as well as the source and target locations and the number of items to be moved. Furthermore, the model is trained based on the properties of the transported items. After training the model to determine an optimal movement path for transporting items using mobile robots and receiving certain information pertaining to the transportation of the items, such as the source and target locations, the number of items to be transported and the properties of the items to be transported, simulations of mobile robots transporting the items from the source location to the target location using various movement paths are performed. An optimal movement path for transporting such items from the source location to the target location is identified using the trained model based on the simulated movement paths, the historical times for the movement of the items using various movement paths, the number of items to be transported and the properties of the items. Mobile robots out of the available mobile robots are then organized to implement the identified optimal movement path to transport the items from the source location to the target location using the optimal movement path. In this manner, items are transported from a source location to a target location, such as in a warehouse, in an efficient manner (lowest item movement time) using artificial intelligence.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

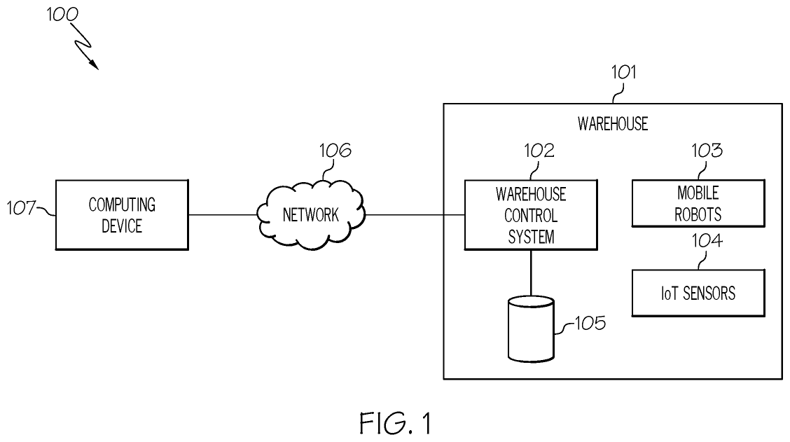

Referring now to the Figures in detail, FIG. 1 illustrates an embodiment of the present disclosure of a communication system 100 for practicing the principles of the present disclosure. Communication system 100 includes a warehouse 101 which includes a warehouse control system 102, autonomous mobile robots (also referred to as “mobile robots” or “robots”) 103 and Internet of Things (IoT) sensors 104.

A “warehouse” 101, as used herein, refers to a building for storing goods. Warehouses 101 are used by manufacturers, importers, exporters, wholesalers, transport businesses, customs, etc. They are usually large plain buildings in industrial parks on the outskirts of cities, towns, or villages.

A “warehouse control system” 102, as used herein, refers to a system for handling the transport of items from a source location to a target location within warehouse 101. In particular, warehouse control system 102 is configured to organize mobile robots to implement a movement path to transport items from the source location to the target location within warehouse 101. A “source location,” as used herein, refers to the location (e.g., aisle A, unit BA, row X) in which an item(s) are picked by a mobile robot. A “target location,” as used herein, refers to the final destination for transporting the picked item(s), such as the packaging zone. A “movement path,” as used herein, refers to a course of movement of picked item(s) from the source location to the target location. There are many different types of movement paths, including an individual movement path, a continuous movement path and a combination of a continuous movement path and an individual movement path. An “individual movement path,” as used herein, refers to utilizing a single mobile robot to transfer an item(s) from a source location to a target location. A “continuous movement path,” as used herein, refers to connecting multiple mobile robots in such a manner where the conveyer belt on each of the connected mobile robots is activated to move the item in the same direction (i.e., conveyer belts of the connected mobile robots are moving in the same direction).

A “mobile robot” (also referred to as an “autonomous mobile robot,” “moveable robot” or “robot”) 103, as used herein, refers to an automatic machine that is capable of locomotion. Mobile robots 103 have the capability to move around in their environment and are not fixed to one physical location. Mobile robots 103 can be “autonomous” in that mobile robots 103 are capable of navigating an uncontrolled environment without the need for physical or electro-mechanical guidance devices. That is, autonomous mobile robots 103 are devices capable of performing tasks and moving around an environment, such as warehouse 101, without the need for human intervention.

Examples of mobile robots 103 utilized in warehouse 101 include, but not limited to, Zebra Fetch Freight 500, Amazon® Hercules, Amazon® Pegasus, Amazon® Xanthus, etc.

In one embodiment, such mobile robots 103 utilize a conveyer belt, such as a conveyer belt located on the top surface of mobile robot 103. In one embodiment, such a conveyer belt may be locked so that the conveyer belt will not move when mobile robot 103 is individually carrying the item from one location to another. Alternatively, such a conveyer belt may be activated to move, including a rotational movement or a forward/backward movement. In one embodiment, warehouse control system 102 determines whether conveyer belt for a particular mobile robot 103 is to be locked or activated based on the movement path to be utilized to transport items from the source location to the target location. In one embodiment, warehouse control system 102 programs mobile robot 103 to operate in such a fashion.

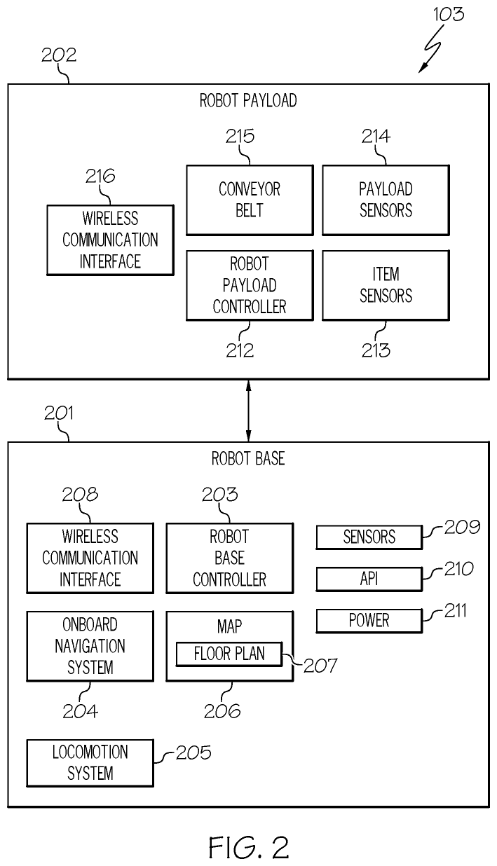

As discussed above, warehouse control system 102 may determine that the optimal movement path for transporting items from the source location to the target location involves a continuous movement path, which involves connecting mobile robots 103 in such a manner where the conveyer belt on each of the connected mobile robots 103 is activated to move the items in the same direction (i.e., conveyer belts of the connected mobile robots 103 are moving in the same direction). In one embodiment, warehouse control system 102 organizes mobile robots 103 to form the continuous movement path by programming mobile robots 103 to connect to one another. “Connecting,” as used herein, refers to a mobile robot 103 being located in close proximity to another mobile robot 103 whereby an item (e.g., lithium battery) being moved on the conveyer belt of mobile robot 103 continues to be moved on the conveyer belt of the adjacent mobile robot 103 since the space between such mobile robots 103 is so small. A description of the primary physical and logical components of mobile robot 103 is provided further below in connection with FIG. 2.

In one embodiment, warehouse control system 102 is configured to utilize artificial intelligence to identify the optimal movement path for transferring items from the source location to the target location within warehouse 101 using mobile robots 103. In one embodiment, a model is built and trained to determine an optimal path for transporting items from the source location to the target location within warehouse 101 using mobile robots 103 either individually or in cooperation with other robots based on simulations of transporting items using different movement paths, historical times for the movement of items using various movement paths as well as the source and target locations, the number of items to be moved and the properties of the items to be moved.

In one embodiment, the historical times for the movement of items using various movement paths is stored in a database 105 connected to warehouse control system 102. Such historical times may have been obtained via IoT sensors 104.

An “IoT sensor” 104, as used herein, refers to a sensor that can be attached to a container (e.g., container of raw materials) or a physical object (e.g., mobile robot 103) or groups of such objects that connect and exchange data with other devices and systems over a network, such as network 106. In one embodiment, IoT sensors 104 are configured to monitor the movement of mobile robots 103 at warehouse 101, including tracking the amount of time that an item(s) take to be transported from a source location to a target location within warehouse 101. In one embodiment, IoT sensors 104 are utilized to obtain time information pertaining to the transporting of items from the source location to the target location to improve efficiency in transporting items from one location to another location within warehouse 101. In one embodiment, such information is provided to warehouse control system 102.

As discussed above, the model is built and trained to determine an optimal path for transporting items from the source location to the target location within warehouse 101 using mobile robots 103 either individually or in cooperation with other robots 103 based on simulations of transporting items using different movement paths, historical times for the movement of items using various movement paths as well as the source and target locations, the number of items to be moved and the properties of the items to be moved. In one embodiment, information, such as the source location, the target location, the number of items to be moved and the properties of the items to be moved, may be obtained from an expert, such as a user of computing device 107 connected to warehouse control system 102 via network 106. In one embodiment, such information may be inputted by an expert to computing device 107 via a graphical user interface. In one embodiment, such information is provided to warehouse control system 102 from computing device 107 via network 106.

In one embodiment, information, such as the properties of the items to be moved may be obtained by warehouse control system 102 from database 105, where such information may have previously been populated in database 105 by an expert. “Properties,” as used herein, refer to the qualities or characteristics of the items to be moved, such as material composition (e.g., glass versus plastic), material dimensions (e.g., length, height, width), weight, etc. Based on such properties, the fragility of the item may be determined, which determines whether or not such an item is capable of being moved on a continuous movement path. In one embodiment, warehouse control system 102 determines the fragility of the item based on fragility curves for material characteristics (properties). Based on such fragility curves, warehouse control system 102 determines the extent of the fragility of the item as identified by a value. In one embodiment, such a value may be compared with a threshold value to determine whether or not such an item is capable of being moved on a continuous movement path. For example, if such a value exceeds a threshold value, then it may be deemed by warehouse control system 102 to not be capable of being moved on a continuous movement path.

In one embodiment, database 105 includes a data structure (e.g., table) with a listing of items and whether or not such items are capable of being moved on a continuous movement path. In one embodiment, warehouse control system 102 utilizes such a data structure to determine whether an item is capable of being moved on a continuous movement path. In one embodiment, such a data structure is populated by an expert.

As discussed above, some of the information to be utilized by the trained model to determine an optimal movement path may be provided by the user of computing device 107. Computing device 107 may be any type of computing device (e.g., portable computing unit, Personal Digital Assistant (PDA), laptop computer, mobile device, tablet personal computer, smartphone, mobile phone, navigation device, gaming unit, desktop computer system, workstation, Internet appliance and the like) configured with the capability of connecting to network 106 and consequently communicating with other computing devices 107 and warehouse control system 102. It is noted that both computing device 107 and the user of computing device 107 may be identified with element number 107.

Network 106 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

In one embodiment, upon identifying the optimal movement path for transporting the items from the source location to the target location, warehouse control system 102 is configured to organize available mobile robots 103 to implement the identified optimal movement path. In one embodiment, warehouse control system 102 tracks which mobile robots 103 are available to be utilized in transporting items within warehouse 101. In one embodiment, one or more of such available mobile robots 103 may be organized by warehouse control system 102 to implement the identified optimal movement path (e.g., continuous movement path). Upon organizing the available mobile robots 103 to implement the identified optimal movement path, the items are then transported from the source location to the target location using the optimal movement path established by the organized mobile robots 103.

A more detailed description of these and other features is provided below.

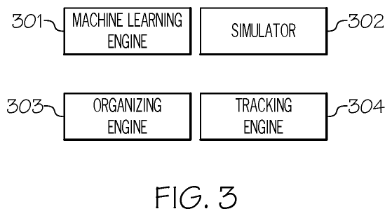

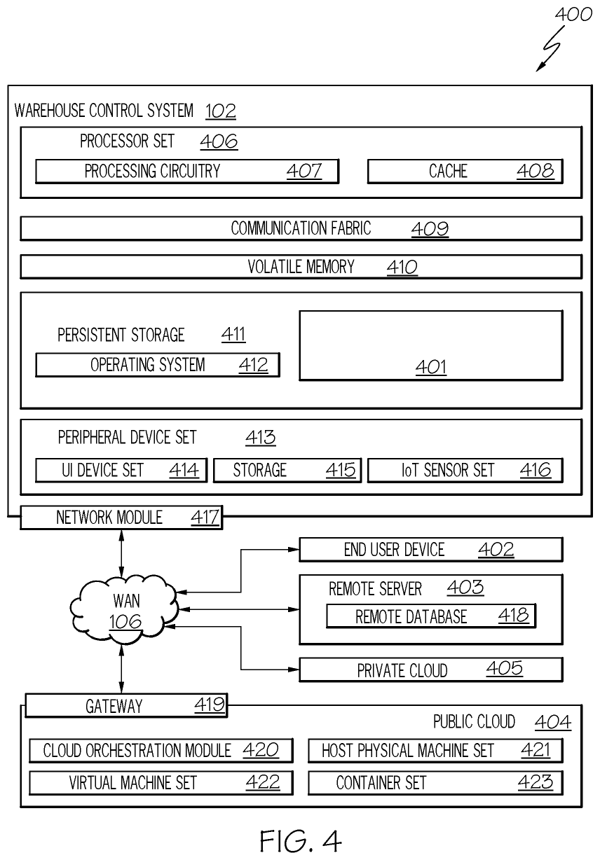

A description of the software components of warehouse control system 102 used for transporting items from one location to another location using an optimal movement path is provided below in connection with FIG. 3. A description of the hardware configuration of warehouse control system 102 is provided further below in connection with FIG. 4.

System 100 is not to be limited in scope to any one particular network architecture. System 100 may include any number of warehouses 101, warehouse control systems 102, mobile robots 103, IoT sensors 104, databases 105, networks 106 and computing devices 107.

A discussion regarding the primary physical and logical components of mobile robot 103 is provided below in connection with FIG. 2.

Referring now to FIG. 2, FIG. 2 illustrates the primary physical and logical components of mobile robot 103 in accordance with an embodiment of the present invention.

As shown in FIG. 2, robot 103 includes a robot base 201 and a robot payload 202. In one embodiment, robot base 201 includes a variety of hardware and software components, including a robot base controller 203, an onboard navigation system 204, a locomotion system 205, a map 206 defining a floor plan 207, such as the floor plan of warehouse 101, a wireless communication interface 208, sensors 209, an application programming interface (API) 210 and a power system 211.

In one embodiment, robot base controller 203 includes computer program instructions executable on a microprocessor (not shown) to initiate, coordinate and manage all of the automation functions associated with mobile robot 103, including without limitation, handling of job assignments, automatic locomotion and navigation, communications with other computers and other robots 103, activating the robot payload functions and controlling power functions. In one embodiment, robot base controller 203 has an assignment manager (not shown) that keeps track of all of the robot's assignments and job operations. When a job assignment is received by mobile robot 103, robot base controller 203 activates the other subsystems in mobile robot 103 to respond to the job assignment. Thus, robot base controller 203 generates and distributes the appropriate command signals that cause other processing modules and units on mobile robot 103 to start carrying out the requested job assignment. So, for example, when the received job assignment requires that mobile robot 103 drive itself to a certain location in the physical environment, such as warehouse 101, it is robot base controller 203 that generates the command signal that causes onboard navigation system 204 to start driving mobile robot 103 to the specified destination. Robot base controller 203 also provides an activation signal for robot payload 202, if necessary, to cause the robot payload 202 to perform a particular operation at the specified job location, which was received from warehouse control system 102. Robot base controller 203 also manages and updates map 206, and floor plan 207, when appropriate, based on updated map or floor plan information received from warehouse control system 102 or other mobile robots 103 in the computer network. Robot base controller 203 also receives assignment status information, if any, from robot payload 202 and, if appropriate, relays the status information out to warehouse control system 102, which typically delegates job assignments to mobile robot 103. Typically, robot base controller 203 will communicate with warehouse control system 102 via an application programming interface (API) 210 and a wireless communications interface 208.

In one embodiment, map 206 defines a floor plan 207 corresponding to the physical environment, such as warehouse 101, and also defines a set of job locations in terms of floor plan 207. In one embodiment, map 206 also associates one or more job operations with one or more of the job locations in the set of job locations. In one embodiment, each job location on floor plan 207 corresponds to an actual location in the physical environment, such as warehouse 101. Some of the job locations on floor plan 207 will also have associated with them a set of one or more job operations to be carried out automatically by mobile robot 103 after mobile robot 103 arrives at the actual location. In one embodiment, map 206 may be obtained by robot base controller 203 from warehouse control system 102 or from another mobile robot 103 or from a standalone operating terminal for the network (not shown). Certain job operations on floor plan 207 may have multiple locations in the physical environment, such as warehouse 101. It is understood, however, that not all job operations need to be pre-programmed into map 206. It is also possible for job operations to be commanded as needed by robot base controller 203, or warehouse control system 102, irrespective of the whether or not the job operation is defined in map 206.

In one embodiment, onboard navigation system 204, operating under the control of robot base controller 203, handles all of the localization, path planning, path following and obstacle avoidance functions for mobile robot 103. If the system includes a positive and negative obstacle avoidance engine to help mobile robot 103 avoid colliding with objects that may be resting on the floor but whose shape is not appropriately identified by the mobile robot's horizontally scanning laser, and to avoid driving into gaps in the floor, this functionality is encompassed by onboard navigation system 204. In one embodiment, onboard navigation system 204 automatically determines the job location for the job assignment based on the map and the job assignment. Using sensors 209, onboard navigation system 204 also detects when driving mobile robot 103 along a selected path (movement path) from the mobile robot's current position to an actual location in the physical environment will cause mobile robot 103 to touch, collide or otherwise come too close to one or more of the stationary or non-stationary obstacles in the physical environment. When onboard navigation system 204 determines that contact with an obstacle might occur, it is able to automatically plan a path around the obstacle and return to the movement path as established by warehouse control system 102. In one embodiment, onboard navigation system 204 may also use sensing lasers to sample objects in the physical environment, and compare the samples with information in map 206. This process is called “laser localization.” Another known technique, called light localization, involves using a camera to find lights in the ceiling and then comparing the lights found to lights identified on map 206. All of these different techniques may be employed to help onboard navigation system 204 determine its current position relative to the job location.

In one embodiment, onboard navigation system 204 operates in combination with locomotion system 205 to drive mobile robot 103 from its current location to the source or target location along the established movement path.

In one embodiment, API 210 is operatable with robot base controller 203 and wireless communication interface 208 to provide information and commands to robot base controller 203 as well as retrieve job assignment status and route information from robot base controller 203. For example, if robot payload 202 needs to send information concerning the status of the item being transported, such information may be transmitted from robot payload controller 212 to robot base controller 203 via API 210. Robot base controller 203 will then transmit such information to warehouse control system 102 through the same API 210. In one embodiment, API 210 is ARCL or ArInterface, an application programming interface distributed by Omron Adept Technologies, Inc. of San Ramon, California.

Sensors 209 may include a collection of different sensors, such as sonar sensors, bumpers, cameras, gas sensors, smoke sensors, motion sensors, etc., and can be used to perform a variety of different functions. These sensors may also be used for traffic mitigation by redirecting mobile robot 103 when other mobile robots 103 are detected in the immediate surroundings. Other elements on robot base 201 include power 211, which typically includes a battery and software to manage the battery.

In one embodiment, locomotion system 205 includes the hardware and electronics necessary for making mobile robot 103 move including, for example, motors, wheels, feedback mechanisms for the motors and wheels, and encoders. In one embodiment, onboard navigation system 204 “drives” mobile robot 103 by sending commands down to the wheels and motors through locomotion system 205.

Referring now to the components of robot payload 202, item sensors 213 provide signals to robot payload controller 212 and, possibly, directly to robot base controller 203 by means of API 210, which permit robot payload controller 212 and/or robot base controller 203 to make programmatic decisions about whether mobile robot 103 has completed an assignment or is available to acquire more items.

In one embodiment, payload sensors 214 may include, for example, temperature or gas sensors, cameras, RFID readers, environmental sensors, wireless Ethernet sniffing sensors, etc. In one embodiment, payload sensors 214 may be used to provide information about the state of robot payload 202, the state of the items on conveyer belt 215, the state of the physical environment, the proximity of mobile robot 103 to physical objects, including other mobile robots 103, or some combination of all of this information.

In one embodiment, conveyer belt 215 resides on the top surface of mobile robot 103. In one embodiment, such a conveyer belt 215 may be locked so that conveyer belt 215 will not move when mobile robot 103 is individually carrying the item from one location to another. Alternatively, such a conveyer belt 215 may be activated to move, including a rotational movement or a forward/backward movement. In one embodiment, warehouse control system 102 determines whether conveyer belt 215 for mobile robot 103 is to be locked or activated based on the movement path to be utilized to transport items from the source location to the target location. In one embodiment, warehouse control system 102 instructs mobile robot 103 to operate in such a fashion via robot payload controller 212.

In one embodiment, robot payload 202 may also include a wireless communications interface 216, which sends information to and receives information from other devices or networks, such as from warehouse control system 102.

In one embodiment, robot payload controller 212 processes command and operation signals coming into robot payload 202 and generally controls and coordinates all of the functions performed by robot payload 202.

A discussion regarding the software components used by warehouse control system 102 to efficiently transport items, such as in a warehouse, by using artificial intelligence is provided below in connection with FIG. 3.

FIG. 3 is a diagram of the software components used by warehouse control system 102 to efficiently transport items, such as in a warehouse, by using artificial intelligence in accordance with an embodiment of the present disclosure.

Referring to FIG. 3, in conjunction with FIG. 1, warehouse control system 102 includes a machine learning engine 301 configured to create or build and train a model to determine an optimal path for transporting items (e.g., calculators) from a source location (e.g., calculators stored on a shelf in warehouse 101) to a target location (e.g., consolidation and packaging zone). An “optimal path,” as used herein, refers to a movement path that takes the least amount of time to transport an item(s) from the source location to the target location. A “movement path,” as used herein, refers to a course of movement of picked item(s) from the source location to the target location. There are many different types of movement paths, including an individual movement path, a continuous movement path and a combination of a continuous movement path and an individual movement path. An “individual movement path,” as used herein, refers to utilizing a single mobile robot to transfer an item(s) from a source location to a target location. A “continuous movement path,” as used herein, refers to connecting multiple mobile robots in such a manner where the conveyer belt on each of the connected mobile robots is activated to move the item in the same direction (i.e., conveyer belts of the connected mobile robots are moving in the same direction).

In one embodiment, the model is trained to predict the optimal path based on historical information pertaining to the movement of items using various movement paths (e.g., individual movement paths, continuous movement paths, a combination of continuous and individual movement paths, etc.). Such historical information includes the times for the movement of the items using various movement paths as well as the source and target locations and the number of items to be moved. Furthermore, the model is trained based on the properties of the transported items.

In one embodiment, the historical times for the movement of items using various movement paths is stored in a database 105 connected to warehouse control system 102. Such historical times may have been obtained via IoT sensors 104.

As stated above, an “IoT sensor” 104, as used herein, refers to a sensor that can be attached to a container (e.g., container of raw materials) or a physical object (e.g., mobile robot 103) or groups of such objects that connect and exchange data with other devices and systems over a network, such as network 106. In one embodiment, IoT sensors 104 are configured to monitor the movement of mobile robots 103 at warehouse 101, including tracking the amount of time that an item(s) take to be transported from a source location to a target location within warehouse 101. In one embodiment, IoT sensors 104 are utilized to obtain time information pertaining to the transporting of items from the source location to the target location to improve efficiency in transporting items from one location to another location within warehouse 101. In one embodiment, such information is provided to warehouse control system 102.

In one embodiment, IoT sensors 104 further obtain the source and target locations and the number of items that are moved. For example, IoT sensors 104 obtain the number of items that were transported, such as six lithium batteries that were transported from the source location to the target location using the continuous movement path in thirty-six seconds. In one embodiment, such information is provided to warehouse control system 102.

As discussed above, the model is built to determine an optimal path for transporting items from the source location to the target location within warehouse 101 using mobile robots 103 either individually or in cooperation with other robots 103 based on historical information pertaining to the movement of items using various movement paths as well as the properties of the transported items.

Information, such as the properties of the transported items, may be obtained by warehouse control system 102 from database 105, where such information may have previously been populated in database 105 by an expert. “Properties,” as used herein, refer to the qualities or characteristics of the items to be moved, such as material composition (e.g., glass versus plastic), material dimensions (e.g., length, height, width), weight, etc. Based on such properties, the fragility of the item may be determined, which determines whether or not such an item is capable of being moved on a continuous movement path. In one embodiment, warehouse control system 102 determines the fragility of the item based on fragility curves for material characteristics (properties). Based on such fragility curves, warehouse control system 102 determines the extent of the fragility of the item as identified by a value. In one embodiment, such a value may be compared with a threshold value to determine whether or not such an item is capable of being moved on a continuous movement path. For example, if such a value exceeds a threshold value, then it may be deemed by warehouse control system 102 to not be capable of being moved on a continuous movement path.

In one embodiment, database 105 includes a data structure (e.g., table) with a listing of items and whether or not such items are capable of being moved on a continuous movement path. In one embodiment, warehouse control system 102 utilizes such a data structure to determine whether an item is capable of being moved on a continuous movement path. In one embodiment, such a data structure is populated by an expert.

In one embodiment, machine learning engine 301 trains the built model to predict the optimal path for transporting a provided number of items from an obtained source location to an obtained target location taking into consideration the properties of the transported items.

In one embodiment, machine learning engine 301 uses a machine learning algorithm (e.g., supervised learning) to build the model to predict the optimal path for transporting items from a source location to a target location using mobile robots 103 using a sample data set containing historical information pertaining to the movement of items using various movement paths from various source locations to various target locations as well as the properties of the transported items.

Such a sample data set is referred to herein as the “training data,” which is used by the machine learning algorithm to make predictions or decisions as to the predicted optimal movement path to be utilized by mobile robots 103 in transporting the items from a source location to a target location. The algorithm iteratively makes predictions on the training data as to the optimal movement path to be utilized by mobile robots 103 in transporting the items from a source location to a target location until the predictions achieve the desired accuracy as determined by an expert. Examples of such learning algorithms include nearest neighbor, Naïve Bayes, decision trees, linear regression, support vector machines and neural networks.

After such a model is trained, it may be utilized to identify the optimal path for transporting items from a source location to a target location within warehouse 101 using mobile robots 103 based on the source location, the target location, a number of the items to be moved, the properties of the items to be transported and the simulated movement paths for transporting such items.

In one embodiment, information, such as the source location, the target location, the number of items to be transported and the properties of the items to be transported, may be obtained from an expert, such as a user of computing device 107 connected to warehouse control system 102 via network 106. In one embodiment, such information may be inputted by an expert to computing device 107 via a graphical user interface.

In one embodiment, the source and target locations are determined by warehouse control system 102 based on a map of warehouse 101, such as map 206, which indicates the locations of various items as well as various target locations for the movement of such items within warehouse 101. In one embodiment, based on receiving an identification of the items (e.g., lithium batteries) as well as a number of such items (e.g., six lithium batteries) to be transported within warehouse 101, such as from a user of computing device 107, one or more source locations (e.g., aisle A, unit BA, row X; aisle B, unit DB, row C) may be determined based on map 206 listing various source locations for such items. Furthermore, map 206 may include a listing of various target locations, which may be pre-filled by an expert, and associated with various items.

In one embodiment, information, such as the properties of the items to be moved may be obtained by warehouse control system 102 from database 105, where such information may have previously been populated in database 105 by an expert. “Properties,” as used herein, refer to the qualities or characteristics of the items to be moved, such as material composition (e.g., glass versus plastic), material dimensions (e.g., length, height, width), weight, etc. Based on such properties, the fragility of the item may be determined, which determines whether or not such an item is capable of being moved on a continuous movement path. In one embodiment, warehouse control system 102 determines the fragility of the item based on fragility curves for material characteristics (properties). Based on such fragility curves, warehouse control system 102 determines the extent of the fragility of the item as identified by a value. In one embodiment, such a value may be compared with a threshold value to determine whether or not such an item is capable of being moved on a continuous movement path. For example, if such a value exceeds a threshold value, then it may be deemed by warehouse control system 102 to not be capable of being moved on a continuous movement path.

In one embodiment, database 105 includes a data structure (e.g., table) with a listing of items and whether or not such items are capable of being moved on a continuous movement path. In one embodiment, warehouse control system 102 utilizes such a data structure to determine whether an item is capable of being moved on a continuous movement path. In one embodiment, such a data structure is populated by an expert.

Additionally, as discussed above, the trained model predicts the optimal path for transporting items based on the simulation of transporting items using different movement paths. Such a simulation may be performed by a simulator 302 of warehouse control system 102.

In one embodiment, simulator 302 is configured to perform simulations of various movement paths to transport the provided number of items from the source location to the target location. In one embodiment, multiple source and target locations may be utilized in the simulation of the various movement paths. In one embodiment, simulator 302 produces a three-dimensional simulation of the movement of items using randomly selected movement paths (e.g., continuous movement path, individual movement path, combination of continuous and individual movement paths) in warehouse 101.

In one embodiment, such a simulation is performed by implementing a simulation model of warehouse 101. In one embodiment, the simulation model is loaded with data pertaining to the different processing times and speeds for mobile robots 103 to transport various items, based on the number of such items as well as the dimensions, weight, etc. of such items. In one embodiment, such information may be inputted by an expert.

In one embodiment, the simulation performed by simulator 302 begins with a physical layout of warehouse 101 with that layout acting as a starting point for the model and for scenario testing. Variables, such as different movement paths (individual movement path, continuous movement path, a combination of a continuous movement path and an individual movement path, etc.) are then tested in the simulation. Such movement paths are tested based on various parameters, such as the number of items to be transported, the different properties of the items (e.g., dimensions, weight), the different locations for the source and target locations, etc. Furthermore, for some movement paths, such as continuous movement paths, mobile robots 103 that are connected together to create the continuous movement path are simulated and tested. The simulation model further tests the impact of such different movement paths, such as the time for transporting the items from the source location to the target location in order to determine the optimal path (i.e., the movement path with the least amount of time to transport the items from a source location to a target location).

In one embodiment, simulator 302 implements various software tools for performing such simulation including, but not limited to, Easy M, Easy S and Automatic Warehouse Studio by Interlake® Mecalux, Emulate3d®, AutoMod®, Simio®, Honeywell® eSim, etc.

Upon performing such simulations of mobile robots 103 transporting a number of items from a source location to a target location using various movement paths, such information is used by the trained model, along with the source and target locations, the number of items (e.g., six lithium batteries) to be transported and the properties of the transported items, to identify an optimal movement path (e.g., continuous movement path) for transporting the provided number of items (e.g., six lithium batteries) from the obtained source location to the obtained target location. Such a prediction is based on the simulated movement paths, the historical times for the movement of such items (e.g., lithium batteries) using various movement paths, the number of such items to be moved (e.g., six) and the properties of such items. For example, the trained model may identify the optimal path to transport six lithium batteries from the source location at aisle X, unit BA, row Z to the target location of the consolidation and packaging zone. Such an optimal path may be identified based on historical information pertaining to the transportation of six lithium batteries from a similar source location to a similar target location. A “similar” source or target location may correspond to a location within a threshold distance to the source/target location. In one embodiment, the threshold distance is user-designated. For example, the historical information as provided by IoT sensors 104 may indicate a transportation time of sixty-two seconds from the source location (or similar source location) to the target location (or similar target location) utilizing six individual movement paths by six separate mobile robots 103 or a transportation time of thirty-six seconds from the source location (or similar source location) to the target location (or similar target location) utilizing a continuous movement path comprised of six connected mobile robots 103. As a result, the model may identify a movement path corresponding to a continuous movement path for transporting such items. Based on the number of the items to be transported, the model may predict a specific number of mobile robots 103 to be utilized in creating such a continuous movement path.

In one embodiment, the model may also identify a movement path involving the separation of a continuous movement path into individual movement paths based on the simulated movement paths, the historical times for the movement of such items using various movement paths, the number of such items to be moved and the properties of such items. For example, it may be more efficient in terms of transportation time to utilize two separate continuous movement paths. Such separate continuous movement paths may be linked using an individual movement path. In one embodiment, one of the continuous movement paths may be previously assigned to be used to transport a different set of items. As a result, such a continuous movement path may not be able to be utilized until the transportation of such items is completed. In one embodiment, various continuous movement paths may be created in which different sets of mobile robots 103 are utilized to organize such continuous movement paths.

In one embodiment, in which multiple source and destination locations are utilized, the model may identify multiple optimal movement paths, such as multiple continuous movement paths to be utilized to transport the requested items. In such a scenario, the model may prioritize which continuous movement path will be created and which continuous movement path will be delayed based on simulator 302 simulating the different scenarios of creating different continuous movement path(s) and delaying other continuous movement path(s) to determine the different item movement times for the different scenarios. Based on such item movement times, the model will prioritize which continuous movement path will be created and which continuous movement path will be delayed based on minimizing the item movement times. In one embodiment, such prioritization may be performed by organizing engine 303 of warehouse control system 102 based, in part, on the availability of mobile robots 103 and their current locations. A further discussion regarding organizing engine 303 is provided below.

After identifying the optimal movement path to transport the requested items, which may include multiple movement paths, organizing engine 303 of warehouse control system 102 organizes the available mobile robots 103 to implement the identified optimal movement path. In one embodiment, the identification of such available mobile robots 103 may be provided to organizing engine 303 from tracking engine 304.

In one embodiment, IoT sensors 104 track which mobile robots 103 are available to be utilized in transporting items within warehouse 101. For example, IoT sensors 104 may be attached to mobile robots 103 to monitor if any items are currently being transported by such mobile robots 103. Those mobile robots 103 that are not being utilized for transporting items are deemed to be available to transport items within warehouse 101. Such information may be provided to tracking engine 304 by IoT sensors 104.

In one embodiment, tracking engine 304 further tracks which mobile robots 103 are available for transporting items based on keeping track of which mobile robots 103 have been assigned to transport items as well as when such mobile robots 103 have completed their assignments, which may be determined based on the estimated time for performing such a task which may be provided by the model as well as based on IoT sensors 104 monitoring when the item transported by mobile robot 103 has reached its target location. When mobile robot 103 has completed its job of transporting an item(s) to its target location, IoT sensor 104 attached to such mobile robot 103 may communicate the completion of the job to tracking engine 304.

In one embodiment, based on the information provided by IoT sensors 104, tracking engine 304 keeps track of which mobile robots 103 are available to transport items and which mobile robots 103 are not available to transport items using various software tools including, but not limited to, moNitrav®, FetchCore®, incubed® IT, etc.

As discussed above, organizing engine 303 of warehouse control system 102 organizes mobile robots 103 that are available to be utilized to implement the identified optimal movement path. In one embodiment, organizing engine 303 organizes one or more available mobile robots 103 to implement the identified optimal movement path based on instructing robot base controller 203 of those mobile robots 103 the job assignment to pick up and transport a specified number of items from a specified source location to a specified destination location, including connecting to another mobile robot 103 if a continuous movement path is to be created. Robot base controller 203 then generates and distributes the appropriate command signals that cause other processing modules and units on mobile robot 103 to start carrying out the requested job assignment. So, for example, when the received job assignment requires that mobile robot 103 drive itself to a certain location in the physical environment, such as warehouse 101, it is robot base controller 203 that generates the command signal that causes onboard navigation system 204 to start driving mobile robot 103 to the specified destination. Furthermore, robot base controller 203 may generate a command signal that causes onboard navigation system 204 to connect with another mobile robot 103 in situations in which a continuous movement path is to be created. Robot base controller 203 also provides an activation signal for robot payload 202, if necessary, to cause robot payload 202 to perform a particular operation at the specified job location, such as to pick up an item(s).

In one embodiment, organizing engine 303 utilizes various software tools for organizing available mobile robots 103 to implement the identified optimal movement path including, but not limited to, moNitrav®, FetchCore®, incubed® IT, etc.

Furthermore, in addition to tracking the availability of mobile robots 103, tracking engine 304 is configured to continuously track item movement using the identified optimal movement path. In one embodiment, such movement is tracked by IoT sensors 104 attached to mobile robots 103 organized to provide such a movement path. For example, such tracked movement may include the movement of mobile robot 103 from the source location to the target location. In one embodiment, IoT sensors 104 provide such information to tracking engine 304.

Additionally, the current duration of time in the transportation of the item(s) using the identified optimal movement path is determined by tracking engine 304. As discussed above, in one embodiment, IoT sensors 104 continuously monitor the movement of mobile robots 103 at warehouse 101, including tracking the current amount of time that an item(s) take to be transported from a source location to its current location as mobile robots 103 travel to the target location within warehouse 101. In one embodiment, IoT sensors 104 are utilized to obtain time information pertaining to the transporting of items by mobile robots 103 from the source location to their current location as they travel to the target location using the identified optimal movement path. In one embodiment, such information is provided to tracking engine 304.

In one embodiment, such information is utilized by tracking engine 304 to determine the estimated amount of remaining time to complete the transportation of the specified number of items to the target location using the optimal movement path. For example, if it is currently taking 20 seconds to transport the specified number of items using the continuous movement path created by six mobile robots 103, then it may be determined that 63 seconds remain for completing such a task based on the remaining distance to be traveled by mobile robots 103 using the continuous movement path to the target location. In one embodiment, the remaining distance for completing the task is determined by tracking engine 304 based on the distance between the current location of mobile robots 103 as obtained by IoT sensors 104 and the location of the target location and the estimated time for traveling such a distance. As previously discussed, the current location of mobile robots 103 may be tracked by IoT sensors 104, where such information is provided to tracking engine 304. In one embodiment, tracking engine 304 determines the distance between the current location of mobile robot(s) 103 organized to form the identified optimal movement path and the target location using a map of warehouse 101, such as map 206 stored in mobile robot 103, which may also be stored in a storage device (e.g., memory, disk unit) of warehouse control system 102.

In one embodiment, tracking engine 304 determines the estimated time to complete the task by mobile robots 103 based on the remaining distance to be traveled by mobile robots 103 to complete the task. In one embodiment, such an estimated time may be determined by tracking engine 304 based on the assumed rate of travel by mobile robots 103, which may be user-designated.

In one embodiment, such information is inputted to the trained model to determine if the identified optimal movement path is still the most optimal movement path for transporting the requested items. For example, information, such as mobile robots 103 needing an additional 62 seconds to transport the specified number of items using the identified optimal continuous movement path created by six mobile robots 103 may be inputted to the trained model. In one embodiment, the trained model may then determine if the previously specified optimal movement path is still the most optimal movement path based on simulating various movements paths for completing the task by simulator 302. Based on such information, it may be determined that a new movement path is to be utilized, including the use of a combination of movement paths, to complete the task. For example, the source location of the new movement path may be a location on the journey of mobile robots 103 traversing the previously specified optimal movement path. Available mobile robots 103 may then be organized by organizing engine 303 to implement the new movement path, including picking up the items to be transported at a source location which corresponds to a location on the journey of mobile robots 103 traversing the previously specified optimal movement path.

If the trained model determines that the previously specified optimal movement path is still the most optimal movement path, then no changes will occur. That is, there will be no modification to the previously assigned optimal movement path.

If, however, the trained model determines that the previously specified optimal movement path is no longer the most optimal movement path, then the trained model will output a new movement path corresponding to the new optimal movement path for completing the task in transporting the specified number of items to the specified destination. As previously discussed, organizing engine 303 would then organize the available mobile robots 103 to implement the new movement path, including picking up the items to be transported at a source location which corresponds to a location on the journey of mobile robots 103 traversing the previously specified optimal movement path.

A further description of these and other features is provided below in connection with the discussion of the method for efficiently transporting items, such as in a warehouse, via autonomous mobile robots using artificial intelligence.

Prior to the discussion of the method for efficiently transporting items, such as in a warehouse, via autonomous mobile robots using artificial intelligence, a description of the hardware configuration of warehouse control system 102 (FIG. 1) is provided below in connection with FIG. 4.

Referring now to FIG. 4, in conjunction with FIG. 1, FIG. 4 illustrates an embodiment of the present disclosure of the hardware configuration of warehouse control system 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code 401 involved in performing the inventive methods, such as efficiently transporting items, such as in a warehouse, via autonomous mobile robots using artificial intelligence. In addition to block 401, computing environment 400 includes, for example, warehouse control system 102, network 106, such as a wide area network (WAN), end user device (EUD) 402, remote server 403, public cloud 404, and private cloud 405. In this embodiment, warehouse control system 102 includes processor set 406 (including processing circuitry 407 and cache 408), communication fabric 409, volatile memory 410, persistent storage 411 (including operating system 412 and block 401, as identified above), peripheral device set 413 (including user interface (UI) device set 414, storage 415, and Internet of Things (IoT) sensor set 416), and network module 417. Remote server 403 includes remote database 418. Public cloud 404 includes gateway 419, cloud orchestration module 420, host physical machine set 421, virtual machine set 422, and container set 423.

Warehouse control system 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 418. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically warehouse control system 102, to keep the presentation as simple as possible. Warehouse control system 102 may be located in a cloud, even though it is not shown in a cloud in FIG. 4. On the other hand, warehouse control system 102 is not required to be in a cloud except to any extent as may be affirmatively indicated.

Processor set 406 includes one, or more, computer processors of any type now known or to be developed in the future. Processing circuitry 407 may be distributed over multiple packages, for example, multiple, coordinated integrated circuit chips. Processing circuitry 407 may implement multiple processor threads and/or multiple processor cores. Cache 408 is memory that is located in the processor chip package(s) and is typically used for data or code that should be available for rapid access by the threads or cores running on processor set 406. Cache memories are typically organized into multiple levels depending upon relative proximity to the processing circuitry. Alternatively, some, or all, of the cache for the processor set may be located “off chip.” In some computing environments, processor set 406 may be designed for working with qubits and performing quantum computing.

Computer readable program instructions are typically loaded onto warehouse control system 102 to cause a series of operational steps to be performed by processor set 406 of warehouse control system 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 408 and the other storage media discussed below. The program instructions, and associated data, are accessed by processor set 406 to control and direct performance of the inventive methods. In computing environment 400, at least some of the instructions for performing the inventive methods may be stored in block 401 in persistent storage 411.

Communication fabric 409 is the signal conduction paths that allow the various components of warehouse control system 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 410 is any type of volatile memory now known or to be developed in the future. Examples include dynamic type random access memory (RAM) or static type RAM. Typically, the volatile memory is characterized by random access, but this is not required unless affirmatively indicated. In warehouse control system 102, the volatile memory 410 is located in a single package and is internal to warehouse control system 102, but, alternatively or additionally, the volatile memory may be distributed over multiple packages and/or located externally with respect to warehouse control system 102.

Persistent Storage 411 is any form of non-volatile storage for computers that is now known or to be developed in the future. The non-volatility of this storage means that the stored data is maintained regardless of whether power is being supplied to warehouse control system 102 and/or directly to persistent storage 411. Persistent storage 411 may be a read only memory (ROM), but typically at least a portion of the persistent storage allows writing of data, deletion of data and re-writing of data. Some familiar forms of persistent storage include magnetic disks and solid state storage devices. Operating system 412 may take several forms, such as various known proprietary operating systems or open source Portable Operating System Interface type operating systems that employ a kernel. The code included in block 401 typically includes at least some of the computer code involved in performing the inventive methods.

Peripheral device set 413 includes the set of peripheral devices of warehouse control system 102. Data communication connections between the peripheral devices and the other components of warehouse control system 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 414 may include components such as a display screen, speaker, microphone, wearable devices (such as goggles and smart watches), keyboard, mouse, printer, touchpad, game controllers, and haptic devices. Storage 415 is external storage, such as an external hard drive, or insertable storage, such as an SD card. Storage 415 may be persistent and/or volatile. In some embodiments, storage 415 may take the form of a quantum computing storage device for storing data in the form of qubits. In embodiments where warehouse control system 102 is required to have a large amount of storage (for example, where warehouse control system 102 locally stores and manages a large database) then this storage may be provided by peripheral storage devices designed for storing very large amounts of data, such as a storage area network (SAN) that is shared by multiple, geographically distributed computers. IoT sensor set 416 is made up of sensors that can be used in Internet of Things applications. For example, one sensor may be a thermometer and another sensor may be a motion detector.

Network module 417 is the collection of computer software, hardware, and firmware that allows warehouse control system 102 to communicate with other computers through WAN 106. Network module 417 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 417 are performed on the same physical hardware device. In other embodiments (for example, embodiments that utilize software-defined networking (SDN)), the control functions and the forwarding functions of network module 417 are performed on physically separate devices, such that the control functions manage several different network hardware devices. Computer readable program instructions for performing the inventive methods can typically be downloaded to warehouse control system 102 from an external computer or external storage device through a network adapter card or network interface included in network module 417.

WAN 106 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 402 is any computer system that is used and controlled by an end user (for example, a customer of an enterprise that operates warehouse control system 102), and may take any of the forms discussed above in connection with warehouse control system 102. EUD 402 typically receives helpful and useful data from the operations of warehouse control system 102. For example, in a hypothetical case where warehouse control system 102 is designed to provide a recommendation to an end user, this recommendation would typically be communicated from network module 417 of warehouse control system 102 through WAN 106 to EUD 402. In this way, EUD 402 can display, or otherwise present, the recommendation to an end user. In some embodiments, EUD 402 may be a client device, such as thin client, heavy client, mainframe computer, desktop computer and so on.

Remote server 403 is any computer system that serves at least some data and/or functionality to warehouse control system 102. Remote server 403 may be controlled and used by the same entity that operates warehouse control system 102. Remote server 403 represents the machine(s) that collect and store helpful and useful data for use by other computers, such as warehouse control system 102. For example, in a hypothetical case where warehouse control system 102 is designed and programmed to provide a recommendation based on historical data, then this historical data may be provided to warehouse control system 102 from remote database 418 of remote server 403.

Public cloud 404 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 404 is performed by the computer hardware and/or software of cloud orchestration module 420. The computing resources provided by public cloud 404 are typically implemented by virtual computing environments that run on various computers making up the computers of host physical machine set 421, which is the universe of physical computers in and/or available to public cloud 404. The virtual computing environments (VCEs) typically take the form of virtual machines from virtual machine set 422 and/or containers from container set 423. It is understood that these VCEs may be stored as images and may be transferred among and between the various physical machine hosts, either as images or after instantiation of the VCE. Cloud orchestration module 420 manages the transfer and storage of images, deploys new instantiations of VCEs and manages active instantiations of VCE deployments. Gateway 419 is the collection of computer software, hardware, and firmware that allows public cloud 404 to communicate through WAN 106.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 405 is similar to public cloud 404, except that the computing resources are only available for use by a single enterprise. While private cloud 405 is depicted as being in communication with WAN 106 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 404 and private cloud 405 are both part of a larger hybrid cloud.

Block 401 further includes the software components discussed above in connection with FIG. 3 to efficiently transport items, such as in a warehouse, via autonomous mobile robots 103 using artificial intelligence. In one embodiment, such components may be implemented in hardware. The functions discussed above performed by such components are not generic computer functions. As a result, warehouse control system 102 is a particular machine that is the result of implementing specific, non-generic computer functions.

In one embodiment, the functionality of such software components of warehouse control system 102, including the functionality for efficiently transporting items, such as in a warehouse, via autonomous mobile robots 103 using artificial intelligence may be embodied in an application specific integrated circuit.

As stated above, a warehouse may utilize hundreds if not thousands of autonomous mobile robots to perform various tasks, such as selectively picking and moving an item (e.g., good), a set of items or even an entire shelf of items from one location in the warehouse to another location in the warehouse. These autonomous mobile robots are equipped with advanced sensors and a digital layout of the warehouse which allows them to interpret their surroundings. Generally, such autonomous mobile robots are charged with moving lightweight unit loads, such as small items, although there are also those made to even handle pallets of goods. In a storage environment, autonomous mobile robots are integrated with a warehouse control system, which, in turn, is linked to the warehouse management system. Aided by software applications, autonomous mobile robots identify and sidestep any obstacles they come across as they move items within the warehouse. Autonomous mobile robots may perform various functions in a warehouse environment, including picking and transporting. For example, a worker may select the item(s) from the shelves and deposit them on the robot. The autonomous mobile robot then serves as a picking cart in which the mobile robot itself takes the item(s) and transports them to a destination, such as the consolidation and packaging zone. In another example, the autonomous mobile robot is responsible for selecting the item(s) from the shelves or even the entire shelf of items. Such item(s) are then transported to a destination, such as the consolidation and packaging zone. In the scenario in which the entire shelf was taken by the mobile robot, the mobile robot may return the shelf to its place and perform the next task. In order to ensure a continuous flow of items within the warehouse, such as a continuous flow of items from a source location (e.g., item located at aisle A, unit BA, row X) to a target destination (e.g., packaging zone), multiple robots may be required to transport such items and/or have the same robot perform multiple trips to transport such items. As a result of such movements by the autonomous mobile robots, the item movement time in the warehouse may be quite large. Unfortunately, there is not currently a means for efficiently transporting items, such as between a source location and a target location within a warehouse, so as to reduce such item movement time in a warehouse.

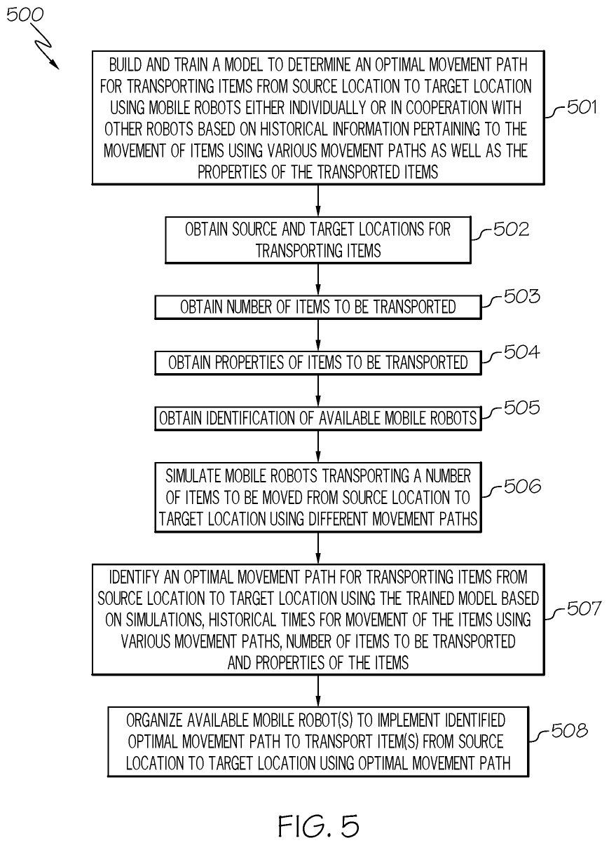

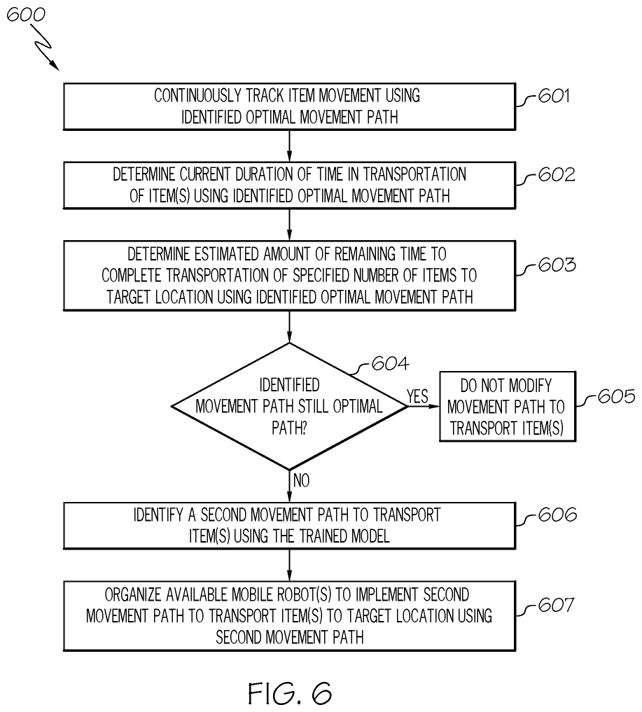

The embodiments of the present disclosure provide a means for efficiently transporting items, such as in a warehouse, by using artificial intelligence to implement a continuous movement path or a combination of a continuous movement path and an individual movement path when it is more efficient to transport such items in such a manner versus simply having multiple mobile robots individually transport such items or having mobile robots make multiple trips to transport such items as discussed below in connection with FIGS. 5-6. FIG. 5 is a flowchart of a method for transporting items between a source location and a target location by mobile robots using artificial intelligence. FIG. 6 is a flowchart of a method for continuously determining an optimal movement path for the mobile robots to utilize to transport the items to the target location.

As stated above, FIG. 5 is a flowchart of a method 500 for transporting items between a source location and a target location by mobile robots using artificial intelligence in accordance with an embodiment of the present invention.

Referring to FIG. 5, in conjunction with FIGS. 1-4, in operation 501, machine learning engine 301 of warehouse control system 102 builds and trains a model to determine an optimal path (or “optimal movement path”) for transporting items from a source location (e.g., aisle X, unit BA, row P) to a target location (e.g., consolidation and packaging zone) using mobile robots 103 either individually or in cooperation with other mobile robots 103 based on historical information pertaining to the movement of items using various movement paths as well as the properties of the transported items.

As discussed above, an “optimal path,” as used herein, refers to a movement path that takes the least amount of time to transport an item(s) from the source location to the target location. A “movement path,” as used herein, refers to a course of movement of picked item(s) from the source location to the target location. There are many different types of movement paths, including an individual movement path, a continuous movement path and a combination of a continuous movement path and an individual movement path. An “individual movement path,” as used herein, refers to utilizing a single mobile robot 103 to transfer an item(s) from a source location to a target location. A “continuous movement path,” as used herein, refers to connecting multiple mobile robots 103 in such a manner where conveyer belt 215 on each of the connected mobile robots 103 is activated to move the item in the same direction (i.e., conveyer belts 215 of the connected mobile robots 103 are moving in the same direction).

In one embodiment, the model is trained to predict the optimal path based on historical information pertaining to the movement of items using various movement paths (e.g., individual movement paths, continuous movement paths, a combination of continuous and individual movement paths, etc.). Such historical information includes the time for the movement of the items using various movement paths as well as the source and target locations and the number of items to be moved. Furthermore, the model is trained based on the properties of the transported items.

In one embodiment, the historical times for the movement of items using various movement paths is stored in a database 105 connected to warehouse control system 102. Such historical times may have been obtained via IoT sensors 104.

As stated above, an “IoT sensor” 104, as used herein, refers to a sensor that can be attached to a container (e.g., container of raw materials) or a physical object (e.g., mobile robot 103) or groups of such objects that connect and exchange data with other devices and systems over a network, such as network 106. In one embodiment, IoT sensors 104 are configured to monitor the movement of mobile robots 103 at warehouse 101, including tracking the amount of time that an item(s) take to be transported from a source location to a target location within warehouse 101. In one embodiment, IoT sensors 104 are utilized to obtain time information pertaining to the transporting of items from the source location to the target location to improve efficiency in transporting items from one location to another location within warehouse 101. In one embodiment, such information is provided to warehouse control system 102.

In one embodiment, IoT sensors 104 further obtain the source and target locations and the number of items that are moved. For example, IoT sensors 104 obtain the number of items that were transported, such as six lithium batteries that were transported from the source location to the target location using the continuous movement path in thirty-six seconds. In one embodiment, such information is provided to warehouse control system 102.

As discussed above, the model is built to determine an optimal path for transporting items from the source location to the target location within warehouse 101 using mobile robots 103 either individually or in cooperation with other robots 103 based on historical information pertaining to the movement of items using various movement paths as well as the properties of the transported items.

Information, such as the properties of the transported items, may be obtained by warehouse control system 102 from database 105, where such information may have previously been populated in database 105 by an expert. “Properties,” as used herein, refer to the qualities or characteristics of the items to be moved, such as material composition (e.g., glass versus plastic), material dimensions (e.g., length, height, width), weight, etc. Based on such properties, the fragility of the item may be determined, which determines whether or not such an item is capable of being moved on a continuous movement path. In one embodiment, warehouse control system 102 determines the fragility of the item based on fragility curves for material characteristics (properties). Based on such fragility curves, warehouse control system 102 determines the extent of the fragility of the item as identified by a value. In one embodiment, such a value may be compared with a threshold value to determine whether or not such an item (e.g., light bulbs) is capable of being moved on a continuous movement path. For example, if such a value exceeds a threshold value, then it may be deemed by warehouse control system 102 that such an item (e.g., light bulbs) is not capable of being moved on a continuous movement path.

In one embodiment, database 105 includes a data structure (e.g., table) with a listing of items and whether or not such items are capable of being moved on a continuous movement path. In one embodiment, warehouse control system 102 utilizes such a data structure to determine whether an item is capable of being moved on a continuous movement path. In one embodiment, such a data structure is populated by an expert.

In one embodiment, machine learning engine 301 trains the built model to predict the optimal path for transporting a provided number of items from a provided source location to a provided target location taking into consideration the properties of the transported items.

In one embodiment, machine learning engine 301 uses a machine learning algorithm (e.g., supervised learning) to build the model to predict the optimal path for transporting items from a source location to a target location using mobile robots 103 using a sample data set containing historical information pertaining to the movement of items using various movement paths from various source locations to various target locations as well as the properties of the transported items.

Such a sample data set is referred to herein as the “training data,” which is used by the machine learning algorithm to make predictions or decisions as to the predicted optimal movement path to be utilized by mobile robots 103 in transporting the items from a source location to a target location. The algorithm iteratively makes predictions on the training data as to the optimal movement path to be utilized by mobile robots 103 in transporting the items from a source location to a target location until the predictions achieve the desired accuracy as determined by an expert. Examples of such learning algorithms include nearest neighbor, Naïve Bayes, decision trees, linear regression, support vector machines and neural networks.

After such a model is trained, it may be utilized to identify the optimal path for transporting items from the source location to the target location within warehouse 101 using mobile robots 103 based on a source location, a target location, a number of the items to be moved, the properties of the items to be transported and the simulated movement paths for transporting such items.

In operation 502, warehouse control system 102 obtains the source and target locations for transporting items.

For example, as discussed above, in one embodiment, information, such as the source location (e.g., aisle S, unit CA, row P) and the target location (e.g., consolidation and packaging zone) within warehouse 101 may be obtained from an expert, such as a user of computing device 107 connected to warehouse control system 102 via network 106. In one embodiment, such information may be inputted by an expert to computing device 107 via a graphical user interface. In one embodiment, such information is provided to warehouse control system 102 from computing device 107 via network 106.

Alternatively, in one embodiment, the source and target locations are determined by warehouse control system 102 based on a map of warehouse 101, such as map 206, which indicates the locations of various items as well as various target locations for the movement of such items within warehouse 101. In one embodiment, based on receiving an identification of the items (e.g., lithium batteries) as well as a number of such items (e.g., six lithium batteries) to be transported within warehouse 101, such as from a user of computing device 107, one or more source locations (e.g., aisle A, unit BA, row X; aisle B, unit DB, row C) may be determined based on map 206 listing various source locations for such items. Furthermore, map 206 may include a listing of various target locations, which may be pre-filled by an expert, and associated with various items. Hence, in such an embodiment, multiple source locations and multiple target locations may be obtained.

In operation 503, warehouse control system 102 obtains a user-specified number of items (e.g., six lithium batteries) to be transported.

For example, as discussed above, in one embodiment, information, such as a user-specified number of items (e.g., six lithium batteries) to be transported within warehouse 101, may be obtained from an expert, such as a user of computing device 107 connected to warehouse control system 102 via network 106. In one embodiment, such information may be inputted by an expert to computing device 107 via a graphical user interface. In one embodiment, such information is provided to warehouse control system 102 from computing device 107 via network 106.

In operation 504, warehouse control system 102 obtains the properties of the items to be transported.

As stated above, in one embodiment, information, such as the properties of the items to be moved may be obtained by warehouse control system 102 from database 105, where such information may have previously been populated in database 105 by an expert. “Properties,” as used herein, refer to the qualities or characteristics of the items to be moved, such as material composition (e.g., glass versus plastic), material dimensions (e.g., length, height, width), weight, etc. Based on such properties, the fragility of the item may be determined, which determines whether or not such an item is capable of being moved on a continuous movement path. In one embodiment, warehouse control system 102 determines the fragility of the item based on fragility curves for material characteristics (properties). Based on such fragility curves, warehouse control system 102 determines the extent of the fragility of the item as identified by a value. In one embodiment, such a value may be compared with a threshold value to determine whether or not such an item is capable of being moved on a continuous movement path. For example, if such a value exceeds a threshold value, then it may be deemed by warehouse control system 102 that such an item is not capable of being moved on a continuous movement path.

In one embodiment, database 105 includes a data structure (e.g., table) with a listing of items and whether or not such items are capable of being moved on a continuous movement path. In one embodiment, warehouse control system 102 utilizes such a data structure to determine whether an item is capable of being moved on a continuous movement path. In one embodiment, such a data structure is populated by an expert.

In operation 505, tracking engine 304 of warehouse control system 102 obtains the identification of available mobile robots 103.

As stated above, in one embodiment, IoT sensors 104 track which mobile robots 103 are available to be utilized in transporting items within warehouse 101. For example, IoT sensors 104 may be attached to mobile robots 103 to monitor if any items are currently being transported by such mobile robots 103. Those mobile robots 103 that are not being utilized for transporting items are deemed to be available to transport items within warehouse 101. Such information may be provided to tracking engine 304 by IoT sensors 104.

In one embodiment, tracking engine 304 further tracks which mobile robots 103 are available for transporting items based on keeping track of which mobile robots 103 have been assigned to transport items as well as when such mobile robots 103 have completed their assignments, which may be determined based on the estimated time for performing such a task which may be provided by the model as well as based on IoT sensors 104 monitoring when the item transported by mobile robot 103 has reached its target location. When mobile robot 103 has completed its job of transporting an item(s) to its target location, IoT sensor 104 attached to such mobile robot 103 may communicate the completion of the job to tracking engine 304.

In one embodiment, based on the information provided by IoT sensors 104, tracking engine 304 keeps track of which mobile robots 103 are available to transport items and which mobile robots 103 are not available to transport items using various software tools including, but not limited to, moNitrav®, FetchCore®, incubed® IT, etc.

In operation 506, simulator 302 of warehouse control system 102 simulates mobile robots 103 transporting a number of items to be moved from the source location to the target location (obtained in operation 502) using different movement paths.

As discussed above, in one embodiment, simulator 302 is configured to perform simulations of various movement paths to transport the provided number of items from the source location to the target location. In one embodiment, multiple source and target locations may be utilized in the simulation of the various movement paths. In one embodiment, simulator 302 produces a three-dimensional simulation of the movement of items using randomly selected movement paths (e.g., continuous movement path, individual movement path, combination of continuous and individual movement paths) in warehouse 101.

In one embodiment, such simulation is performed by implementing a simulation model of warehouse 101. In one embodiment, the simulation model is loaded with data pertaining to the different processing times and speeds for mobile robots 103 to transport various items, based on the number of such items as well as the dimensions, weight, etc. of such items. In one embodiment, such information may be inputted by an expert.

In one embodiment, the simulation performed by simulator 302 begins with a physical layout of warehouse 101 with that layout acting as a starting point for the model and for scenario testing. Variables, such as different movement paths (individual movement path, continuous movement path, a combination of a continuous movement path and an individual movement path, etc.) are then tested in the simulation. Such movement paths are tested based on various parameters, such as the number of items to be transported (obtained in operation 503), the different properties of the items (e.g., dimensions, weight) (obtained in operation 504), the different locations for the source and target locations (obtained in operation 502), etc. Furthermore, for some movement paths, such as continuous movement paths, mobile robots 103 that are connected together to create the continuous movement path are simulated and tested. The simulation model further tests the impact of such different movement paths, such as the time for transporting the items from the source location to the target location in order to determine the optimal path (i.e., the movement path with the least amount of time to transport the items from the source location to the target location).

In one embodiment, simulator 302 implements various software tools for performing such simulation including, but not limited to, Easy M, Easy S and Automatic Warehouse Studio by Interlake® Mecalux, Emulate3d®, AutoMod®, FlexSIM®, Simio®, Honeywell® eSim, etc.

Upon performing such simulations of mobile robots 103 transporting a number of items from a source location to a target location using various movement paths, such information is used by the trained model, along with the obtained source and target locations (see operation 502), the number of items to be transported (see operation 503) and the properties of the transported items (see operation 504), to identify an optimal movement path (e.g., continuous movement path) for transporting the provided number of items (e.g., six lithium batteries) from the obtained source location to the obtained target location as discussed below in connection with operation 507.

In operation 507, warehouse control system 102 identifies an optimal movement path for transporting items from the source location to the target location using the trained model based on the simulated movement paths, the historical times for the movement of the items using various movement paths, the number of items to be transported and the properties of the items.

As discussed above, the trained model (see operation 501) utilized by warehouse control system 102 makes such a prediction (identifies an optimal movement path) based on the simulated movement paths, the historical times for the movement of such items using various movement paths, the number of such items to be moved and the properties of such items. For example, the trained model may identify the optimal path to transport six lithium batteries from the source location at aisle X, unit CA, row Z to the target location of the consolidation and packaging zone. Such an optimal path may be identified based on historical information pertaining to the transportation of six lithium batteries from a similar source location to a similar target location. A “similar” source or target location may correspond to a location within a threshold distance to the obtained source/target location. In one embodiment, the threshold distance is user-designated. For example, the historical information as provided by IoT sensors 104 may indicate a transportation time of sixty-two seconds from the source location (or similar source location) to the target location (or similar target location) utilizing six individual movement paths by six separate mobile robots 103 or a transportation time of thirty-six seconds from the source location (or similar source location) to the target location (or similar target location) utilizing a continuous movement path comprised of six connected mobile robots 103. As a result, the model may identify a movement path corresponding to a continuous movement path for transporting such items. Based on the number of the items to be transported, the model may predict a specific number of mobile robots 103 to be utilized in creating such a continuous movement path.

In one embodiment, the model may also identify a movement path involving the separation of a continuous movement path into individual movement paths based on the simulated movement paths, the historical times for the movement of such items using various movement paths, the number of such items to be moved and the properties of such items. For example, it may be more efficient in terms of transportation time to utilize two separate continuous movement paths. Such separate continuous movement paths may be linked using an individual movement path. In one embodiment, one of the continuous movement paths may be previously assigned to be used to transport a different set of items. As a result, such a continuous movement path may not be able to be utilized until the transportation of such items is completed. In one embodiment, various continuous movement paths may be created in which different sets of mobile robots 103 are utilized to organize such continuous movement paths.

In one embodiment, in which multiple source and destination locations are utilized, the model may identify multiple optimal movement paths, such as multiple continuous movement paths to be utilized to transport the requested items. In such a scenario, the model may prioritize which continuous movement path will be created and which continuous movement path will be delayed based on simulator 302 simulating the different scenarios of creating different continuous movement path(s) and delaying other continuous movement path(s) to determine the different item movement times for the different scenarios. Based on such item movement times, the model will prioritize which continuous movement path will be created and which continuous movement path will be delayed based on minimizing the item movement times. In one embodiment, such prioritization may be performed by organizing engine 303 of warehouse control system 102 based, in part, on the availability of mobile robots 103 and their current locations.

In operation 508, organizing engine 303 of warehouse control system 102 organizes available mobile robot(s) (those mobile robots 103 that are available to be utilized as determined in operation 505) to implement the identified optimal movement path to transport the items from the source location to the target location using the optimal movement path.

As stated above, after identifying the optimal movement path to transport the requested items, which may include multiple movement paths, organizing engine 303 of warehouse control system 102 organizes the available mobile robots 103 to implement the identified optimal movement path. In one embodiment, the identification of such available mobile robots 103 may be provided to organizing engine 303 from tracking engine 304.

Furthermore, as discussed above, organizing engine 303 of warehouse control system 102 organizes mobile robots 103 that are available to be utilized to implement the identified optimal movement path. In one embodiment, organizing engine 303 organizes one or more available mobile robots 103 to implement the identified optimal movement path based on instructing robot base controller 203 of those mobile robots 103 the job assignment to pick up and transport a specified number of items from a specified source location to a specified destination location, including connecting to another mobile robot 103 if a continuous movement path is to be created. Robot base controller 203 then generates and distributes the appropriate command signals that cause other processing modules and units on mobile robot 103 to start carrying out the requested job assignment. So, for example, when the received job assignment requires that mobile robot 103 drive itself to a certain location in the physical environment, such as warehouse 101, it is robot base controller 203 that generates the command signal that causes onboard navigation system 204 to start driving mobile robot 103 to the specified destination. Furthermore, robot base controller 203 may generate a command signal that causes onboard navigation system 204 to connect with another mobile robot 103 in situations in which a continuous movement path is to be created. Robot base controller 203 also provides an activation signal for robot payload 202, if necessary, to cause robot payload 202 to perform a particular operation at the specified job location, such as to pick up an item(s).

In one embodiment, organizing engine 303 utilizes various software tools for organizing available mobile robots 103 to implement the identified optimal movement path including, but not limited to, moNitrav®, FetchCore®, incubed® IT, etc.

After implementing the identified optimal movement path, tracking engine 304 may continuously track the item movement using such a movement path to ensure that the movement path is still the most optimal and efficient manner in transporting the items to the target location as discussed below in connection with FIG. 6.

FIG. 6 is a flowchart of a method 600 for continuously determining an optimal movement path for mobile robots 103 to utilize to transport the items to the target location in accordance with an embodiment of the present disclosure.

Referring to FIG. 6, in conjunction with FIGS. 1-5, in operation 601, tracking engine 304 of warehouse control system 102 continuously tracks the item movement using the identified optimal movement path.

As discussed above, in one embodiment, such movement is tracked by IoT sensors 104 attached to mobile robots 103 organized to provide such a movement path. For example, such tracked movement may include the movement of mobile robot 103 from the source location to the target location. In one embodiment, IoT sensors 104 provide such information to tracking engine 304.

In operation 602, tracking engine 304 of warehouse control system 102 determines the current duration of time in the transportation of the item(s) using the identified movement path.

As stated above, the current duration of time in the transportation of the item(s) using the identified optimal movement path is determined by tracking engine 304. As discussed above, in one embodiment, IoT sensors 104 continuously monitor the movement of mobile robots 103 at warehouse 101, including tracking the current amount of time that an item(s) take to be transported from a source location to its current location as mobile robots 103 travel to the target location within warehouse 101. In one embodiment, IoT sensors 104 are utilized to obtain time information pertaining to the transporting of items by mobile robots 103 from the source location to their current location as they travel to the target location using the identified optimal movement path. In one embodiment, such information is provided to tracking engine 304.

In operation 603, tracking engine 304 of warehouse control system 102 determines the estimated amount of remaining time to complete the transportation of the specified number of items to the target location using the optimal movement path.

As discussed above, in one embodiment, such information is utilized by tracking engine 304 to determine the estimated amount of remaining time to complete the transportation of the specified number of items to the target location using the optimal movement path. For example, if it is currently taking 20 seconds to transport the specified number of items using the continuous movement path created by six mobile robots 103, then it may be determined that 63 seconds remain for completing such a task based on the remaining distance to be traveled by mobile robots 103 using the continuous movement path to the target location. In one embodiment, the remaining distance for completing the task is determined by tracking engine 304 based on the distance between the current location of mobile robots 103 as obtained by IoT sensors 104 and the location of the target location and the estimated time for traveling such a distance. As previously discussed, the current location of mobile robots 103 may be tracked by IoT sensors 104, where such information is provided to tracking engine 304. In one embodiment, tracking engine 304 determines the distance between the current location of mobile robot(s) 103 organized to form the identified optimal movement path and the target location using a map of warehouse 101, such as map 206 stored in mobile robot 103, which may also be stored in a storage device (e.g., storage device 411, 415) of warehouse control system 102.

In one embodiment, tracking engine 304 determines the estimated time to complete the task by mobile robots 103 based on the remaining distance to be traveled by mobile robots 103 to complete the task. In one embodiment, such an estimated time may be determined by tracking engine 304 based on the assumed rate of travel by mobile robots 103, which may be user-designated.

In operation 604, tracking engine 304 of warehouse control system 102 determines whether the identified optimal movement path is still the most optimal movement for transporting the user-designated number of items from the source location to the target location.

As stated above, in one embodiment, information, such as the determined estimated amount of remaining time to complete the transportation of the specified number of items to the target location using the optimal movement path, is inputted to the trained model to determine if the identified optimal movement path is still the most optimal movement path. For example, information, such as mobile robots 103 needing an additional 62 seconds to transport the specified number of items using the identified optimal continuous movement path created by six mobile robots 103 may be inputted to the trained model. In one embodiment, the trained model may then determine if the previously specified optimal movement path is still the most optimal movement path based on simulating various movements paths for completing the task by simulator 302. Based on such information, it may be determined that a new movement path is to be utilized, including the use of a combination of movement paths, to complete the task. For example, the source location of the new movement path may be a location on the journey of mobile robots 103 traversing the previously specified optimal movement path. Available mobile robots 103 may then be organized by organizing engine 303 to implement the new movement path, including picking up the items to be transported at a source location which corresponds to a location on the journey of mobile robots 103 traversing the previously specified optimal movement path.

If the trained model determines that the previously specified optimal movement path is still the most optimal movement path, then, in operation 605, no changes will occur. That is, there will be no modification to the previously assigned optimal movement path.

If, however, the trained model determines that the previously specified optimal movement path is no longer the most optimal movement path, then, in operation 606, warehouse control system 102 using the trained model identifies a second movement path as the new optimal movement path to transport the items.

As discussed above, if the trained model determines that the previously specified optimal movement path is no longer the most optimal movement path, then the trained model will output a new movement path corresponding to the new optimal movement path for completing the task in transporting the specified number of items to the specified destination.

In operation 607, organizing engine 303 of warehouse control system 102 organizes the available mobile robots 103 to implement the new movement path, including picking up the items to be transported at a source location which corresponds to a location during the journey of mobile robots 103 in traversing the previously specified optimal movement path to the target location.

As a result of the foregoing, embodiments of the present disclosure provide a means for efficiently transporting items, such as in a warehouse, by using artificial intelligence to implement a continuous movement path or a combination of a continuous movement path and an individual movement path when it is more efficient to transport items in such a manner versus simply having multiple mobile robots individually transport such items or having mobile robots make multiple trips to transport such items.

Furthermore, the principles of the present disclosure improve the technology or technical field involving autonomous mobile robots in transporting items. As discussed above, a warehouse may utilize hundreds if not thousands of autonomous mobile robots to perform various tasks, such as selectively picking and moving an item (e.g., good), a set of items or even an entire shelf of items from one location in the warehouse to another location in the warehouse. These autonomous mobile robots are equipped with advanced sensors and a digital layout of the warehouse which allows them to interpret their surroundings. Generally, such autonomous mobile robots are charged with moving lightweight unit loads, such as small items, although there are also those made to even handle pallets of goods. In a storage environment, autonomous mobile robots are integrated with a warehouse control system, which, in turn, is linked to the warehouse management system. Aided by software applications, autonomous mobile robots identify and sidestep any obstacles they come across as they move items within the warehouse. Autonomous mobile robots may perform various functions in a warehouse environment, including picking and transporting. For example, a worker may select the item(s) from the shelves and deposit them on the robot. The autonomous mobile robot then serves as a picking cart in which the mobile robot itself takes the item(s) and transports them to a destination, such as the consolidation and packaging zone. In another example, the autonomous mobile robot is responsible for selecting the item(s) from the shelves or even the entire shelf of items. Such item(s) are then transported to a destination, such as the consolidation and packaging zone. In the scenario in which the entire shelf was taken by the mobile robot, the mobile robot may return the shelf to its place and perform the next task. In order to ensure a continuous flow of items within the warehouse, such as a continuous flow of items from a source location (e.g., item located at aisle A, unit BA, row X) to a target destination (e.g., packaging zone), multiple robots may be required to transport such items and/or have the same robot perform multiple trips to transport such items. As a result of such movements by the autonomous mobile robots, the item movement time in the warehouse may be quite large. Unfortunately, there is not currently a means for efficiently transporting items, such as between a source location and a target location within a warehouse, so as to reduce such item movement time in a warehouse.

Embodiments of the present disclosure improve such technology by building and training a model to determine an optimal movement path for transporting items using mobile robots either individually or in cooperation with other mobile robots. In one embodiment, each of the mobile robots has a conveyor belt configured to carry or move one or more items, where each of the mobile robots is configured to connect with other mobile robots to create a continuous movement path whereby the conveyer belt on each of the connected mobile robots used to create the continuous movement path is activated to move an item in a same direction. An “optimal movement path” (also referred to herein as simply “optimal path”), as used herein, refers to a movement path that takes the least amount of time to transport an item(s) from the source location to the target location. A “movement path,” as used herein, refers to a course of movement of picked item(s) from the source location to the target location. There are many different types of movement paths, including an individual movement path, a continuous movement path and a combination of a continuous movement path and an individual movement path. An “individual movement path,” as used herein, refers to utilizing a single mobile robot to transfer an item(s) from a source location to a target location. A “continuous movement path,” as used herein, refers to connecting multiple mobile robots in such a manner where the conveyer belt on each of the connected mobile robots is activated to move the item in the same direction (i.e., conveyer belts of the connected mobile robots are moving in the same direction). In one embodiment, the model is trained to predict the optimal path based on historical information pertaining to the movement of items using various movement paths (e.g., individual movement paths, continuous movement paths, a combination of continuous and individual movement paths, etc.). Such historical information includes the time for the movement of the items using various movement paths as well as the source and target locations and the number of items to be moved. Furthermore, the model is trained based on the properties of the transported items. After training the model to determine an optimal movement path for transporting items using mobile robots and receiving certain information pertaining to the transportation of the items, such as the source and target locations, the number of items to be transported and the properties of the items to be transported, simulations of mobile robots transporting the items from the source location to the target location using various movement paths are performed. An optimal movement path for transporting such items from the source location to the target location is identified using the trained model based on the simulated movement paths, the historical times for the movement of the items using various movement paths, the number of items to be transported and the properties of the items. Mobile robots out of the available mobile robots are then organized to implement the identified optimal movement path to transport the items from the source location to the target location using the optimal movement path. In this manner, items are transported from a source location to a target location, such as in a warehouse, in an efficient manner (lowest item movement time) using artificial intelligence. Furthermore, in this manner, there is an improvement in the technical field involving autonomous mobile robots in transporting items.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for transporting items from one location to another location, the method comprising:
building and training a model to determine a movement path for transporting items using one or more of a plurality of mobile robots either individually or in cooperation with other mobile robots, wherein each of said plurality of mobile robots has a conveyor belt configured to carry or move one or more items, wherein each of said plurality of mobile robots is configured to connect with other mobile robots to create a continuous movement path whereby said conveyer belt on each of said connected mobile robots used to create said continuous movement path is activated to move an item in a same direction;
obtaining a source location for a plurality of items to be picked;
obtaining a target location to receive said plurality of items transported from said source location;
simulating mobile robots transporting said plurality of items from said source location to said target location using an individual movement path, said continuous movement path or a combination of said individual movement path and said continuous movement path;
identifying a first movement path for transporting said plurality of items from said source location to said target location using said trained model based on said simulations and historical times for movement of items using various movement paths; and
organizing one or more mobile robots of a plurality of available mobile robots to implement said first movement path to transport said plurality of items from said source location to said target location.

2. The method as recited in claim 1, wherein said organizing of said one or more mobile robots of said plurality of available mobile robots involves connecting two or more mobile robots to create said continuous movement path.

3. The method as recited in claim 1, wherein said organizing of said one or more mobile robots of said plurality of available mobile robots involves splitting an existing continuous movement path into individual movement paths.

4. The method as recited in claim 1, wherein said organizing of said one or more mobile robots of said plurality of available mobile robots involves utilizing a first continuous movement path connected with a second continuous movement path via an individual movement path.

5. The method as recited in claim 1 further comprising:
continuously tracking item movement using said first movement path;
determining a current duration of time in transportation of said plurality of items using said first movement path; and
determining an estimated amount of remaining time to complete transportation of said plurality of items to said target location using said first movement path.

6. The method as recited in claim 5 further comprising:
determining, using said trained model, if said first movement path still corresponds to a movement path with a shortest time for transporting said plurality of items to said target location;
identifying a second movement path using said trained model in response to determining that said first movement path no longer corresponds to said movement path with said shortest time for transporting said plurality of items to said target location and in response to determining that said second movement path corresponds to said movement path with said shortest time for transporting said plurality of items to said target location; and
organizing one or more mobile robots of said plurality of available mobile robots to implement said second movement path to transport said plurality of items to said target location.

7. The method as recited in claim 1, wherein said source location and said target location are located within a warehouse.

8. A computer program product for transporting items from one location to another location, the computer program product comprising one or more computer readable storage mediums having program code embodied therewith, the program code comprising programming instructions for:
building and training a model to determine a movement path for transporting items using one or more of a plurality of mobile robots either individually or in cooperation with other mobile robots, wherein each of said plurality of mobile robots has a conveyor belt configured to carry or move one or more items, wherein each of said plurality of mobile robots is configured to connect with other mobile robots to create a continuous movement path whereby said conveyer belt on each of said connected mobile robots used to create said continuous movement path is activated to move an item in a same direction;
obtaining a source location for a plurality of items to be picked;
obtaining a target location to receive said plurality of items transported from said source location;
simulating mobile robots transporting said plurality of items from said source location to said target location using an individual movement path, said continuous movement path or a combination of said individual movement path and said continuous movement path;
identifying a first movement path for transporting said plurality of items from said source location to said target location using said trained model based on said simulations and historical times for movement of items using various movement paths; and
organizing one or more mobile robots of a plurality of available mobile robots to implement said first movement path to transport said plurality of items from said source location to said target location.

9. The computer program product as recited in claim 8, wherein said organizing of said one or more robots of said plurality of available mobile robots involves connecting two or more mobile robots to create said continuous movement path.

10. The computer program product as recited in claim 8, wherein said organizing of said one or more mobile robots of said plurality of available mobile robots involves splitting an existing continuous movement path into individual movement paths.

11. The computer program product as recited in claim 8, wherein said organizing of said one or more mobile robots of said plurality of available mobile robots involves utilizing a first continuous movement path connected with a second continuous movement path via an individual movement path.

12. The computer program product as recited in claim 8, wherein the program code further comprises the programming instructions for:
continuously tracking item movement using said first movement path;
determining a current duration of time in transportation of said plurality of items using said first movement path; and
determining an estimated amount of remaining time to complete transportation of said plurality of items to said target location using said first movement path.

13. The computer program product as recited in claim 12, wherein the program code further comprises the programming instructions for:
determining, using said trained model, if said first movement path still corresponds to a movement path with a shortest time for transporting said plurality of items to said target location;
identifying a second movement path using said trained model in response to determining that said first movement path no longer corresponds to said movement path with said shortest time for transporting said plurality of items to said target location and in response to determining that said second movement path corresponds to said movement path with said shortest time for transporting said plurality of items to said target location; and
organizing one or more mobile robots of said plurality of available mobile robots to implement said second movement path to transport said plurality of items to said target location.

14. The computer program product as recited in claim 8, wherein said source location and said target location are located within a warehouse.

15. A system, comprising:
a memory for storing a computer program for transporting items from one location to another location; and
a processor connected to said memory, wherein said processor is configured to execute program instructions of the computer program comprising:
building and training a model to determine a movement path for transporting items using one or more of a plurality of mobile robots either individually or in cooperation with other mobile robots, wherein each of said plurality of mobile robots has a conveyor belt configured to carry or move one or more items, wherein each of said plurality of mobile robots is configured to connect with other mobile robots to create a continuous movement path whereby said conveyer belt on each of said connected mobile robots used to create said continuous movement path is activated to move an item in a same direction;
obtaining a source location for a plurality of items to be picked;
obtaining a target location to receive said plurality of items transported from said source location;
simulating mobile robots transporting said plurality of items from said source location to said target location using an individual movement path, said continuous movement path or a combination of said individual movement path and said continuous movement path;
identifying a first movement path for transporting said plurality of items from said source location to said target location using said trained model based on said simulations and historical times for movement of items using various movement paths; and
organizing one or more mobile robots of a plurality of available mobile robots to implement said first movement path to transport said plurality of items from said source location to said target location.

16. The system as recited in claim 15, wherein said organizing of said one or more mobile robots of said plurality of available mobile robots involves connecting two or more mobile robots to create said continuous movement path.

17. The system as recited in claim 15, wherein said organizing of said one or more mobile robots of said plurality of available mobile robots involves splitting an existing continuous movement path into individual movement paths.

18. The system as recited in claim 15, wherein said organizing of said one or more mobile robots of said plurality of available mobile robots involves utilizing a first continuous movement path connected with a second continuous movement path via an individual movement path.

19. The system as recited in claim 15, wherein the program instructions of the computer program further comprise:
continuously tracking item movement using said first movement path;
determining a current duration of time in transportation of said plurality of items using said first movement path; and
determining an estimated amount of remaining time to complete transportation of said plurality of items to said target location using said first movement path.

20. The system as recited in claim 19, wherein the program instructions of the computer program further comprise:
determining, using said trained model, if said first movement path still corresponds to a movement path with a shortest time for transporting said plurality of items to said target location;
identifying a second movement path using said trained model in response to determining that said first movement path no longer corresponds to said movement path with said shortest time for transporting said plurality of items to said target location and in response to determining that said second movement path corresponds to said movement path with said shortest time for transporting said plurality of items to said target location; and
organizing one or more mobile robots of said plurality of available mobile robots to implement said second movement path to transport said plurality of items to said target location.
